(19) United States
(12) Patent Application Publication
(10) Pub. No.: US 2025/0358857 A1
(43) Pub. Date: Nov. 20, 2025

(54) DYNAMIC MAPPING OF RANDOM ACCESS OCCASIONS TO BEAMS

(71) Applicant: QUALCOMM Incorporated, San Diego, CA (US)

(72) Inventors: Kiran VENUGOPAL, Green Brook, NJ (US); Yan ZHOU, San Diego, CA (US)

(21) Appl. No.: 18/668,003

(22) Filed: May 17, 2024

(51) Int. Cl. H04W 74/0833; H04L 1/08; H04W 72/044

(52) U.S. Cl. CPC H04W 74/0833; H04L 1/08; H04W 72/046

(57) ABSTRACT

Certain aspects of the present disclosure provide techniques for dynamic mapping of random access occasions to transmission beams. An example method for wireless communications by an apparatus includes obtaining a first configuration for random access communications, wherein the first configuration includes a first explicit indication of a first mapping of a first subset of random access occasions of a plurality of random access occasions to a first synchronization signal block (SSB); and sending first signaling in at least one random access occasion of the first subset of random access occasions associated with the first SSB.

### INTRODUCTION

### Field of the Disclosure

Aspects of the present disclosure relate to wireless communications, and more particularly, to techniques for random access communications.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes obtaining a first configuration for random access communications, wherein the first configuration includes a first explicit indication of a first mapping of a first subset of random access occasions of a plurality of random access occasions to a first synchronization signal block (SSB); and sending first signaling in at least one random access occasion of the first subset of random access occasions associated with the first SSB.

Another aspect provides a method for wireless communications by an apparatus. The method includes sending a first configuration for random access communications, wherein the first configuration includes a first explicit indication of a first mapping of a first subset of random access occasions of a plurality of random access occasions to a first SSB; and obtaining first signaling in at least one random access occasion of the first subset of random access occasions associated with the first SSB.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5A depicts an example four-step random access procedure.

FIG. 5B depicts an example two-step random access procedure.

FIG. 6A depicts an example wireless communications network.

FIG. 6B depicts an example scheme for mapping random access occasions (ROs) to synchronization signal blocks (SSBs) of FIG. 6A.

FIG. 7A depicts an example mapping of a set of RO(s) to one or more SSBs.

FIG. 7B depicts an example mapping of an RO group to one or more SSBs.

FIG. 8 depicts a process flow for dynamic mapping of random access occasions to beams.

FIG. 9 depicts a method for wireless communications.

FIG. 10 depicts another method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for dynamic mapping of random access occasions to transmission beams.

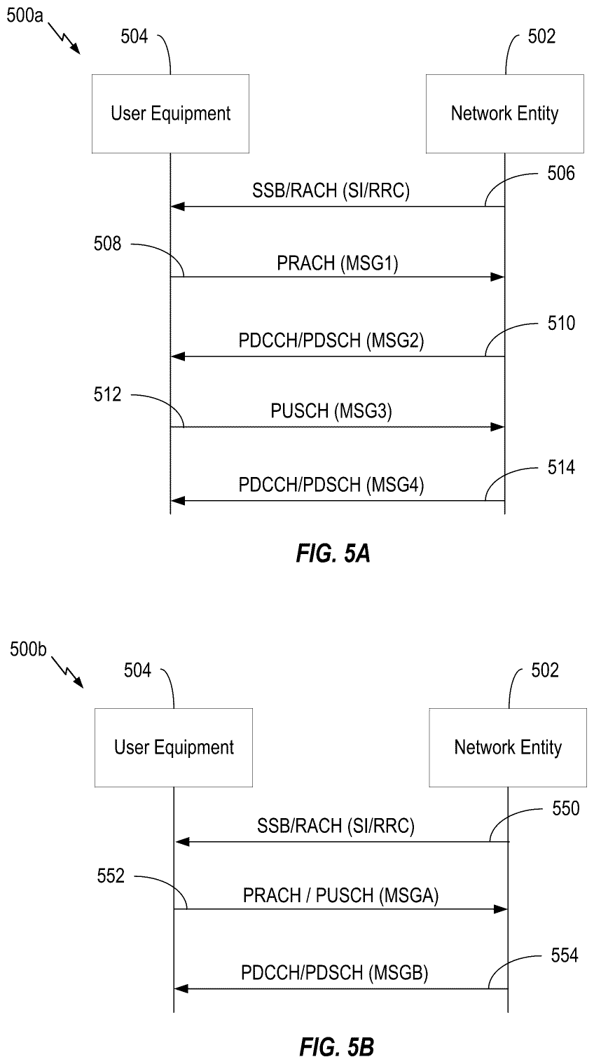

In certain wireless communication systems (e.g., 5G New Radio (NR) systems and/or any future wireless communications system), a user equipment (UE) may communicate with a network entity (e.g., a base station) using a random access procedure, for example, for initial access to the network entity, for beam failure recovery, to obtain timing information (e.g., a timing advance), to request uplink communication resources, to request system information, to perform a handover, etc. An example random access procedure may begin with the UE sending a random access preamble on a physical random access channel (PRACH) in a random access occasion (RO) (e.g., corresponding to a time-frequency resource) (also referred to as a RACH occasion), which may include one or more time-frequency resources. Upon successful reception of the preamble, the network entity sends, to the UE, a response to the preamble in a random access response (RAR) window. The response may include an uplink scheduling grant. On receiving the response, the UE may send a request to setup a connection with the network entity, and then, the network entity may reply with a contention resolution response. Certain aspects associated with random access communications are further described herein, for example, with respect to FIGS. 5A and 5B.

In some cases, the network entity may send, to the UE, the random access response via a specific transmission beam (transmit beam of the network entity). The RO used by the UE to communicate the preamble associated with the random access response may be associated with the specific transmission beam, for example, based on a synchronization signal block (SSB) associated with the RO. In particular, the transmission beam used by the network entity to send the random access response to the UE may be based on an RO in which the UE transmits the preamble to the network entity.

For example, during an SSB burst (e.g., a sequence of SSBs communicated in a periodic cycle), the network entity may perform a transmission beam sweep via SSBs by sending one or more SSBs per transmission beam of the network entity. The UE may measure the received signal power of the SSBs, and the UE may select the SSB that has a received signal power that satisfies a threshold, such as that SSB has a best received signal power among the SSBs. Each of the SSBs may be mapped to or associated with one or more ROs (e.g., by a configuration, predefined, etc.). In particular, the UE may be configured with a mapping of SSB indexes to ROs determined according to certain mapping rule(s). The UE may map the selected SSB to an RO mapped to the SSB in the SSB to RO mapping, and send the preamble in the RO. The RO may be associated with the same transmission beam of the network entity as the network entity used to transmit the SSB associated with the RO. Accordingly, the network entity may transmit the random access response to the UE using the transmission beam of the network entity associated with the RO.

In certain aspects, the mapping rule(s) of an SSB to RO mapping may distribute the association of SSBs equally across the ROs, such that each of the SSBs may be associated with the same number of ROs in a periodic cycle of ROs. For example, the mapping rule(s) may indicate that successive SSB indexes may be mapped to RO identifiers based first in order of preamble indexes within an RO, then in order of frequency resource indexes for the ROs (e.g., PRACH frequency occasions), and then in order of time resource indexes for the ROs (e.g., PRACH time occasions) in PRACH slots.

Technical problem(s) for random access communications may include, for example, providing an effective RO distribution for SSBs. In certain cases, the traffic load associated with different SSBs of a network entity may be different, for example, due to UEs being concentrated in a particular coverage area (e.g., direction) associated with a transmission beam of the network entity associated with an SSB versus other coverage area(s) associated with other transmission beams of the network entity associated with other SSBs. For example, when there are more UEs in a first coverage area associated with a first transmission beam associated with a first SSB than there are UEs in a second coverage area associated with a second transmission beam associated with a second SSB, there may be more preambles sent in ROs associated with the first SSB than preambles sent in ROs associated with the second SSB. Thus, the ROs allocated for the first SSB may become overloaded with preamble transmissions, whereas the ROs allocated for the second SSB may be unused or underused for preamble transmissions.

In some cases, the channel conditions between different SSBs (e.g., and corresponding transmission beam) of a network entity may differ, for example, due to certain conditions for interference, reflections, diffractions, fading, and/or scattering depending on the transmission beam associated with SSBs. As an example, a first transmission beam associated with a first SSB may exhibit greater interference than a second transmission beam associated with a second SSB, and thus, the interference may affect the received signal power of the first SSB at the UEs receiving the first SSB. Therefore, less preambles may be sent in ROs associated with the first SSB.

In certain cases, different types of UEs may have different transmission coverage capabilities, such as a low-complexity, low-power UEs (e.g., Internet-of-Things (IoT) devices). Some UEs, such as those with low-complexity and/or that transmit with low-power, may use RO repetitions to enhance the transmission coverage for communications. RO repetition(s) may refer to a set of ROs allocated for one or more preamble repetitions that repeat in time and/or frequency. A UE using RO repetition may transmit a preamble over multiple repetitions of an RO, and a network entity may combine the preamble transmissions received in the RO repetitions to decode the preamble. UEs using RO repetition may further use more ROs. Such UEs may be more concentrated in a particular coverage area or direction associated with a particular transmission beam of an SSB, and therefore, more preambles may be sent in ROs associated with the SSB.

Some mapping rule(s) may not be able to account for the various communication conditions (e.g., traffic load, channel conditions, coverage capabilities, etc.) that may cause some SSBs to be associated with ROs that are more often used for transmission of preambles and some SSBs to be associated with ROs that are less often used for transmission of preambles. For example, the mapping rule(s) may not be capable of allocating more ROs to one SSB over another SSB. Moreover, the use of ROs associated with different SSBs may change over time, such as due to changes in communication conditions associated with an SSB, and the mapping rule(s) may not allow a change in the allocation of ROs to an SSB, such as to accommodate the change in communication conditions without affecting the equal distribution of ROs to SSBs.

In certain cases, the SSBs of a network entity may be communicated via multiple transmission-reception points (TRPs), which may be arranged in different locations. The mapping rule(s) described herein may not take into account or consider the TRPs used for communicating SSBs. As the mapping rule(s) may provide an equal distribution of ROs to SSBs, the mapping rule(s) may not allow the ROs assigned to different TRPs to overlap in time in order to provide low latency, spatial diversity, and/or certain coverage enhancements via repetitions.

Aspects described herein may overcome the aforementioned technical problem(s), for example, by providing dynamic mapping of ROs to transmission beams (e.g., and associated SSBs). In certain aspects, a UE may obtain an indication of a transmission beam-specific RO allocation pattern, which may associate the transmission beam, and its associated SSB, with a subset of ROs among a plurality of ROs available for random access communications in a periodic cycle of ROs. A subset may refer to a portion (e.g., less than all) of a plurality of elements. For example, the plurality of ROs may be configured at the UE, such as by signaling (e.g., system information) indicating time-frequency resources of the plurality of ROs, or preconfigured at the UE, such as according to a rule. The indication of the transmission beam-specific RO allocation pattern may indicate RO identifiers of the subset of ROs, time-frequency resource(s) of the subset of ROs, or the like. As an example, the transmission beam-specific RO allocation pattern may include a mapping of the subset of ROs to one or more SSBs. In certain cases, the transmission beam-specific RO allocation may be conveyed via SSB-specific system information. In certain aspects, the UE may obtain an explicit indication (e.g., a specific bit, value, etc. such as a field or parameter dedicated to indicating the mapping) of the mapping of the subset of ROs to an SSB. In certain aspects, the explicit indication may include a bitmap of ROs enabled for the SSB among the plurality of ROs available for random access communications. In certain aspects, the explicit indication may include a selection of an RO allocation pattern (e.g., index of the RO allocation pattern) for the SSB among a plurality of RO allocation patterns. In certain aspects, the explicit indication may indicate the time-frequency resource(s) or RO identifiers for RO repetitions in an RO group.

Certain techniques for dynamic mapping of ROs to transmission beams described herein may provide various beneficial technical effects and/or advantages. The techniques for dynamic mapping of ROs to transmission beams may enable improved wireless communication performance, such as dynamic load balancing, coverage enhancements, and/or reduced latencies for random access communications. The load balancing may be attributable to the dynamic mapping allocating a subset of ROs to a specific SSB, such as based at least in part on the traffic load encountered for the coverage area of the SSB and/or other communication conditions associated with the SSB. The coverage enhancements may be attributable to the dynamic mapping allocating a subset of ROs with repetitions to a specific SSB based at least in part coverage capabilities of UEs in the coverage area of the SSB. The reduced latencies may be attributable to the dynamic mapping allocating a subset of ROs to a specific SSB with reduced time gaps between ROs and/or with a shorter periodicity. Accordingly, the dynamic mapping of ROs to transmission beams may enable the RO allocation for a specific SSB to take into account or consider the various communication conditions associated with the SSB, and in some cases, to time-varying changes in such communication conditions.

The term “beam” may be used in the present disclosure in various contexts. Beam may be used to mean a set of gains and/or phases (e.g., precoding weights or co-phasing weights) applied to antenna elements in (or associated with) a wireless communication device for transmission or reception. The term “beam” may also refer to an antenna or radiation pattern of a signal transmitted while applying the gains and/or phases to the antenna elements. Other references to beam may include one or more properties or parameters associated with the antenna (or radiation) pattern, such as an angle of arrival (AoA), an angle of departure (AoD), a gain, a phase, a directivity, a beam width, a beam direction (with respect to a plane of reference) in terms of azimuth and/or elevation, a peak-to-side-lobe ratio, and/or an antenna (or precoding) port associated with the antenna (radiation) pattern. The term “beam” may also refer to an associated number and/or configuration of antenna elements (e.g., a uniform linear array, a uniform rectangular array, or other uniform array).

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

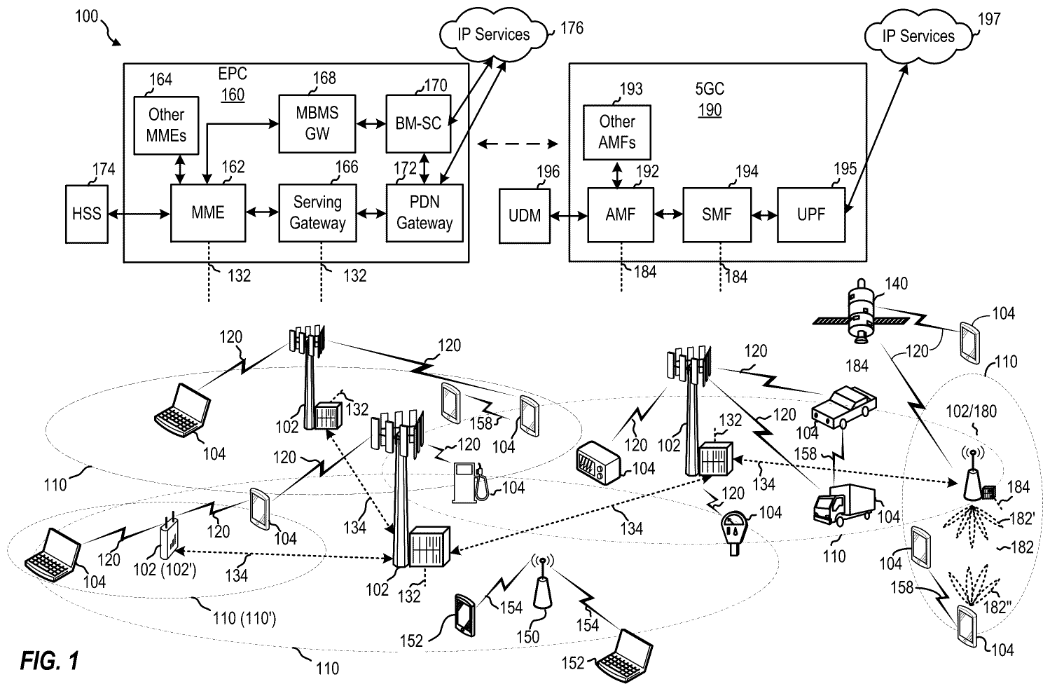

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

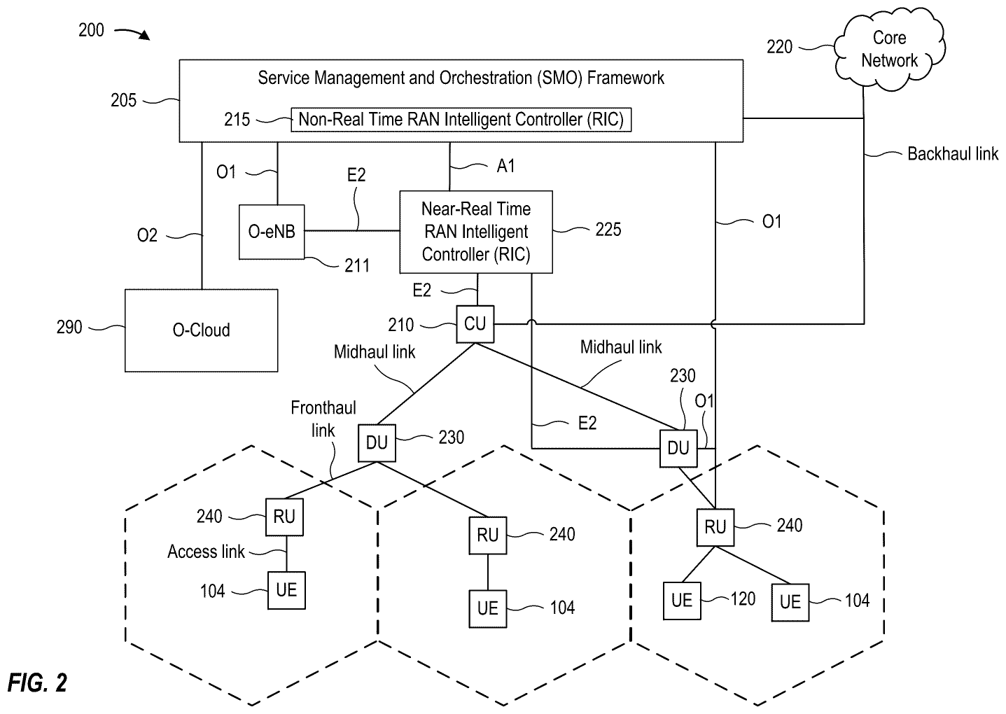

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

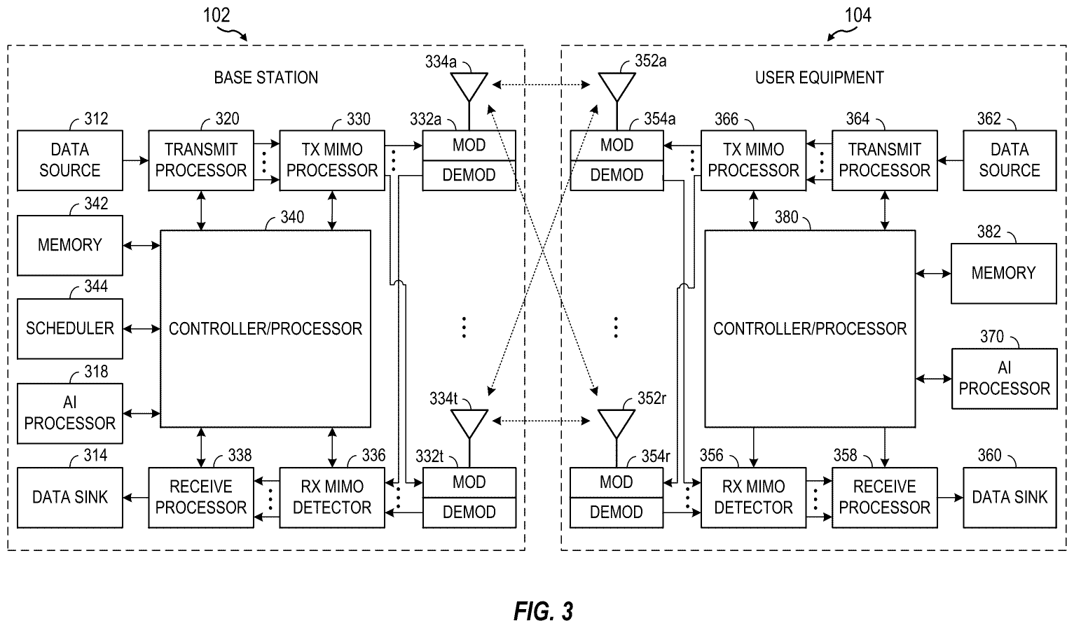

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

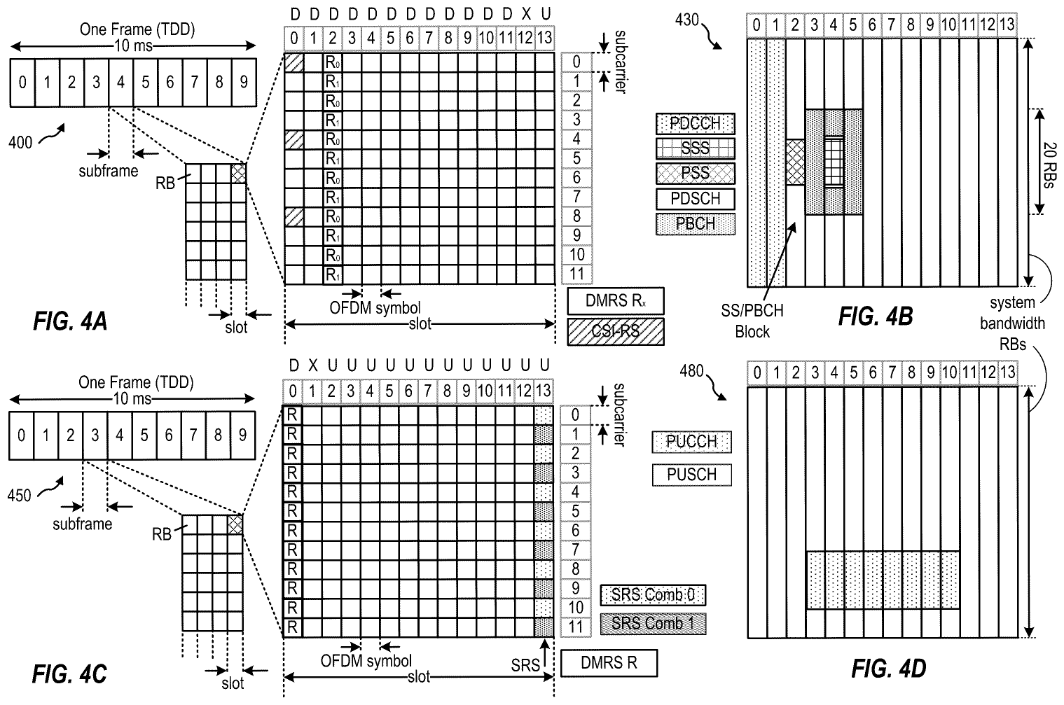

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 24 slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 24× 15 kHz, where u is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Random Access Procedures

Certain wireless communication systems (e.g., a 5G NR system and/or any future wireless communications system) may provide a specified channel for random access, such as a random access channel (RACH), and corresponding random access procedure(s). As discussed above, random access procedure may be performed for any of various events including, for example, initial access from an idle state (e.g., RRC idle), RRC connection re-establishment, handover, downlink (DL) and/or uplink (UL) data arrival (e.g., when the UE is in an idle state), timing synchronization, or device positioning.

FIG. 5A depicts a process flow diagram of an example four-step RACH procedure 500a performed between a UE 504 and a network entity 502. In some aspects, the UE 504 is the UE 104 depicted and described with respect to FIGS. 1 and 3, and the network entity 502 is the base station 102 depicted and described with respect to FIGS. 1 and 3 or a disaggregated base station depicted and described with respect to FIG. 2.

The RACH procedure 500a may optionally begin at 506, where the network entity 502 broadcasts and the UE 504 receives a random access configuration, for example, in system information (SI) within a synchronization signal block (SSB), or within an RRC message. The random access configuration may indicate or include one or more parameters for random access communications, such as defining the RACH, the total number of random access preambles (e.g., preamble sequences) available for random access, power ramping parameters, response window size (duration), etc.

At 508, the UE 504 sends a first message (MSG1) to the network entity 502 on a physical random access channel (PRACH). In some cases, a PRACH may be referred to as a RACH. In certain aspects, MSG1 may indicate or include a RACH preamble. The RACH preamble may be or include a preamble sequence (e.g., a Zaddoff Chu sequence). For contention-based random access, the preamble sequence may be randomly selected among a set of preamble sequences (e.g., up to 64 sequences, in some cases). The preamble sequence may be used to identify the UE 504 for scheduling communications (e.g., MSG2 and MSG3) with the network entity. In certain aspects, terms such as “RACH preamble,” “random access preamble,” “preamble,” “preamble sequence,” “sequence,” and the like may be used interchangeably.

At 510, the network entity 502 may respond with a random access response (RAR) message (MSG2). For example, the network entity 502 may send a PDCCH communication including downlink control information (DCI) that schedules the RAR on the PDSCH. The RAR may include, for example, certain parameters used for an uplink transmission such as a random access (RA) preamble identifier (RAPID), a timing advance, an uplink (UL) grant (e.g., indicating one or more time-frequency resources for an uplink transmission), cell radio network temporary identifier (C-RNTI), and/or a backoff parameter value. The RAPID may correspond to the preamble sequence and indicate that the RAR is for the UE 504 that transmitted MSG1 at 506. The backoff parameter value may be used to determine a RACH occasion (RO) for sending a subsequent RACH transmission (e.g., a preamble transmission). A RACH occasion may correspond to one or more time-frequency resources available for transmitting a preamble in a RACH.

At 512, in response to MSG2, the UE 504 transmits a third message (MSG3) to the network entity 502 on the PUSCH. In some aspects, MSG3 may include an RRC connection request, a tracking area update (e.g., for UE mobility), and/or a scheduling request (for an UL transmission). As an example, MSG3 is communicated in the time-frequency resource(s) indicated in the UL grant of the RAR.

At 514, the network entity 502 may send a contention resolution message (MSG4) in response to MSG3. The network entity 502 may send a downlink scheduling command (e.g., DCI), which is addressed to a specific UE identity associated with the UE 504 as discussed below, via the PDCCH. The network entity 502 may send a UE contention resolution identity (e.g., a medium access control element) via the PDSCH according to the downlink scheduling command. In certain cases, multiple UEs may send the same preamble in the same RO. As the network entity 502 may not be able to identify which UE sent which preamble, the network entity 502 may reply with a single RAR associated with the preamble. The MSG3 may include or indicate a specific UE identity associated with the UE 504, such as a radio network temporary identifier (RNTI) or a temporary mobile subscriber identity (TMSI). The network entity 502 may decode MSG3 and determine the UE identity associated with at least one of the UEs (e.g., UE 504). MSG4 may be addressed to the UE identity (e.g., the RNTI or an RNTI based on the TMSI) associated with the MSG3 that the network entity was able to successfully decode. For example, the MSG4 may be scrambled by the RNTI associated with the MSG3. If the UE 504 obtains the same identity sent in MSG3, the UE 504 concludes that the random access procedure succeeded. In some cases, if the UE 504 is unable to obtain or decode MSG3 and/or MSG4, the UE 504 may repeat the RACH procedure, such as the four-step RACH procedure 500a.

In some cases, to reduce the latency associated with random access, a two-step RACH procedure may be used. As the name implies, the two-step RACH procedure may effectively consolidate the four messages of the four-step RACH procedure into two messages.

FIG. 5B depicts a process flow diagram of an example two-step RACH procedure 500b performed between the UE 504 and the network entity 502.

The procedure 500b may optionally begin at 550, where the network entity 502 broadcasts and the UE 504 receives a random access configuration, for example in system information within a synchronization signal block, or within an RRC message.

At 552, the UE 504 sends a first message (MSGA) to the network entity 502, which may effectively combine MSG1 and MSG3 described above with respect to FIG. 5A. In some aspects, MSGA includes a RACH preamble for random access and a payload. For example, the payload may include a UE-ID and other signaling information, such as a buffer status report or scheduling request. The RACH preamble of MSGA may be transmitted over the PRACH, and the payload of MSGA may be transmitted over the PUSCH, for example.

At 554, the network entity 502 may send a random access response message (MSGB), which may effectively combine MSG2 and MSG4 described above, via the PDCCH and PDSCH. For example, MSGB may include a RAPID, a timing advance, a backoff parameter value, a contention resolution message, an uplink and/or downlink grant, and transmit power control commands.

### Aspects Related to Dynamic Mapping of Random Access Occasions to Beams

Aspects of the present disclosure provide dynamic mapping of ROs to transmission beams (e.g., associated with SSBs). In certain aspects, the mapping of an RO to a transmission may be indicated via a mapping of an RO to an SSB, which is communicated via the corresponding transmission beam. A mapping of an RO to an SSB may indicate an association between the RO and the SSB or that the RO is linked to the SSB. For example, when a UE sends a random access message (e.g., a RACH preamble) via a RO as described herein with respect to FIGS. 5A and 5B, the RO (via the RO-to-SSB mapping, association, or link) indicates the transmission beam (such as the beam corresponding to the SSB) for a network entity to use for sending a random access response to the UE (e.g., MSG2 of FIG. 5A). Thus, the dynamic mapping of ROs to transmission beams may enable dynamic load balancing, coverage enhancements, and/or reduced latencies for random access communications as further described herein.

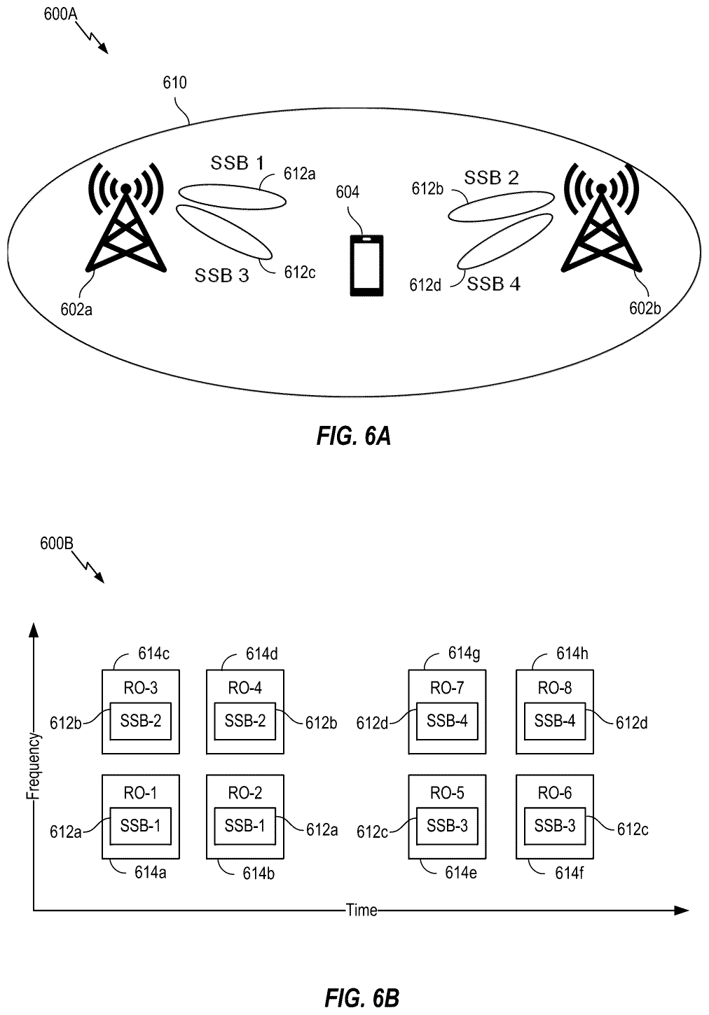

FIG. 6A depicts an example wireless communications network 600A where dynamic mapping of RO(s) to transmission beam(s) may enable an effective RO allocation for the transmission beams. In this example, the wireless communications network 600A may include a first network entity 602a and a second network entity 602b. Each of the network entities 602a, 602b may be or include a base station or one or more disaggregated entities thereof. For example, each of the network entities 602a, 602b may be an example of a transmission-reception point (TRP) or a radio unit (e.g., the RU 240 of FIG. 2), such as of a single base station or different base stations. A UE 604 may be located in a coverage area 610 of the first network entity 602a and second network entity 602b. The coverage area 610 may correspond to a serving cell associated with the network entities 602a, 602b. The UE 604 may be in communication with the network entities 602a, 602b. The first network entity 602a may send a first SSB 612a and a third SSB 612c via a first transmission beam and a third transmission beam, respectively; and the second network entity 602b may send a second SSB 612b and a fourth SSB 612d via a second transmission beam and a fourth transmission beam, respectively.

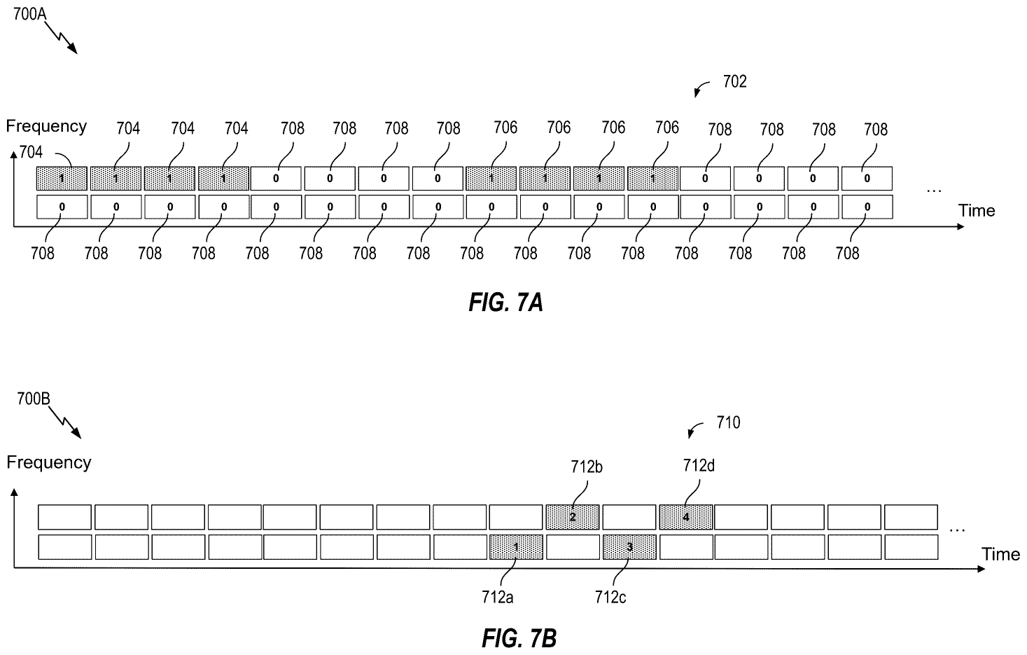

In certain aspects, the UE 604 may be configured with one or more dynamic mappings of a set of ROs to one or more SSBs. The UE 604 may obtain configuration(s) that include(s) an explicit indication of mapping(s) of a set of ROs to at least one of the SSBs 612a-d, for example, as further described herein with respect to FIGS. 6B, 7A, and 7B. In certain aspects, an explicit indication of a dynamic mapping of a set of ROs to one or more SSBs may be indicated or conveyed via various types of signaling, such as a bitmap, a RO pattern selection or indication, and/or machine learning techniques, as further described herein. The dynamic mapping of the set of ROs to SSB(s) may be communicated via system information, radio resource control (RRC) signaling, medium access control (MAC) signaling, and/or downlink information (DCI). In certain aspects, the dynamic mapping of the set of ROs to SSB(s) may be provided per SSB. For example, the dynamic mapping of the set of ROs to SSB(s) may be carried in SSB-specific system information, such as remaining minimum system information (RMSI) associated with the SSB and/or system information carried via the SSB.

FIG. 6B depicts an example scheme 600B for mapping ROs to the SSBs 612a-d of FIG. 6A based on dynamic mapping(s). In this example, a first RO 614a and a second RO 614b may be associated with the first SSB 612a, which may be communicated via the first transmission beam of the first network entity 602a. A third RO 614c and a fourth RO 614d may be associated with the second SSB 612b, which may be communicated via the second transmission beam of the second network entity 602b. The first RO 614a and second RO 614b may overlap at least partially (e.g., partially overlap) in time with the third RO 614c and the fourth RO 614d, respectively. For example, at least a portion of the first RO 614a may overlap in time with the third RO 614c to enable spatial diversity and low latency random access communications between the first network entity 602a and the second network entity 602b. In certain cases, the first RO 614a may overlap in time with the third RO 614c.

A fifth RO 614e and a sixth RO 614f may be associated with the third SSB 612c, which may be communicated via the third transmission beam of the first network entity 602a. A seventh RO 614g and an eighth RO 614h may be associated with the fourth SSB 612d, which may be communicated via the fourth transmission beam of the second network entity 602b. The fifth RO 614e and sixth RO 614f may overlap at least partially in time with the seventh RO 614g and eighth RO 614h, respectively. Note that the SSBs 612a-d depicted in FIG. 6B are illustrating the association between the respective RO and SSB and not the time-frequency resource(s) used to communicate the SSBs 612a-d; whereas the ROs 614a-f are depicting the time-frequency resource(s) for communicating the respective ROs.

In certain aspects, the UE 604 may obtain an (explicit) indication of a dynamic RO-to-SSB mapping(s) for each of the SSBs 612a-d (or a subset thereof). For example, a first mapping may indicate an association between the first SSB 612a and a first subset of ROs of a plurality of ROs including the ROs 614a-h. The first subset of ROs may include the first RO 614a and the second RO 614b. A second mapping may indicate an association between the second SSB 612b and a second subset of ROs including the third RO 614c and the fourth RO 614d. A third mapping may indicate an association between the third SSB 612c and a third subset of ROs including the fifth RO 614e and the sixth RO 614f. A fourth mapping may indicate an association between the fourth SSB 612d and a fourth subset of ROs including the seventh RO 614g and the eighth RO 614h.

An explicit indication of a mapping of a subset of ROs to an SSB may be a value, such as a bit or set of bits, of a field or parameter included in a configuration, that is dedicated to (e.g., specific to) indicating the mapping between the subset of ROs and an SSB. The explicit indication may be or include a specific value of a field or parameter dedicated to indicating the mapping. This may differ from an implicit indication, where a value in the configuration, such as that indicates some other parameter (e.g., the time-frequency arrangement of ROs across a set of slots), is used as an indication of the RO to SSB mapping, for example, through the mapping rule(s) described herein. For example, an explicit indication may provide more flexibility for defining the mapping (or association) between ROs and SSBs, as the indication of the mapping is not then tied to the value of some other parameter (such as the mapping rule(s) that distribute SSBs to ROs equally). Thus, the explicit indication may enable dynamic load balancing, coverage enhancements, and/or reduced latencies for random access communications.

In certain cases, a dynamic RO-to-SSB mapping may allow the association of an RO group to one or more SSBs. In certain cases, an RO group may be or include a set of ROs associated with one or more SSBs. For example, a UE may send multiple PRACH transmissions (e.g., preamble transmissions) with the same transmission beam association (e.g., the same SSB association). The multiple PRACH transmissions may be in the ROs of an RO group, and in certain cases, the RO group may include RO(s) allocated for PRACH repetition transmission(s) (e.g., to convey or carry the same preamble payload). An RO group may include an RO and one or more repetition occasions for multiple PRACH transmissions, for example, that carry or include the same preamble payload. A repetition occasion may be or include an RO allocated for communication of a preamble repetition. A network entity may obtain the PRACH transmissions in the RO group and perform joint detection and/or joint decoding of the payload (e.g., the preamble) conveyed in the RO group. Thus, the RO group may be or include a set of ROs, associated with one or more SSBs, that may be used for joint detection and/or joint decoding at a network entity.

As an example, a first RO group may include the first RO 614a and the second RO 614b, where the second RO 614b may be a repetition occasion for the first RO 614a. A second RO group may include the third RO 614c and the fourth RO 614d with the fourth RO 614d, where the fourth RO 614b may be a repetition occasion for the third RO 614c. As shown, the second RO 614b, which may be a repetition occasion, may overlap (partially or completely) in time with the fourth RO 614b, which may be a repetition occasion.

For a given SSB identity, the starting RO of a first RO group may be the first valid RO (in order of time and/or frequency) in a specific time duration (e.g., time duration X). A valid RO may be determined according to certain random access communication standards. As an example, the first RO 614a may be an example of the first valid RO, and the first RO group may include the first RO 614a and the second RO 614b. The starting RO of a second (e.g., next) RO group may be the next valid RO after the last RO of the first RO group (e.g., the second RO 614b), and the starting RO of the second RO group may be determined first in increasing order of frequency, then in increasing order of time. For example, the third RO 614c may be an example of the starting RO of the second RO group, and the second RO group may include the third RO 614c and the fourth RO 614d. In certain aspects, the remaining N−1 ROs in the first RO group may have the same starting resource block as the starting RO. The time duration X may be determined such that each SSB has at least one RO group with N PRACH repetitions (e.g., communicated via repetition occasion(s)) in the time duration X. A dynamic RO-to-SSB mapping may allocate ROs in an RO group associated with one or more SSBs, and in certain aspects, the dynamic RO-to-SSB mapping may allow RO groups to be allocated that overlap in time, such as the first RO group and the second RO group described herein. Accordingly, the dynamic RO-to-SSB mapping described herein may allow a UE to be configured with an RO allocation for one or more RO groups associated with one or more SSBs.

Such dynamic RO-to-SSB mapping(s) may allow random access communications to be distributed across multiple TRPs, such as the first network entity 602a and the second network entity 602b of FIG. 6A. The dynamic mapping(s) may allow the allocation of simultaneous ROs associated with different SSBs at the first network entity and the second network entity, such as along with simultaneous RO repetitions per SSB beam. In certain aspects, RO groups may be associated with multiple TRPs. Accordingly, the dynamic RO-to-SSB mapping(s) may enable reduced latencies (e.g., via simultaneous or time-overlapping ROs and/or RO groups per TRP), spatial diversity (e.g., via multiple TRPs), and/or coverage enhancements (e.g., via RO(s) for repetitions of a preamble transmission).

FIG. 7A depicts an example mapping 700A of a set of ROs to one or more SSBs. The mapping 700A may be indicated as being specific to or associated with one or more SSBs (for example, the SSB 612a-d of FIG. 6). The mapping 700A may indicate that a first set of ROs (for example, including RO(s) 704, 706 depicted with the label “1”) are activated among a plurality of ROs 702 available for random access communications (e.g., PRACH transmission(s)). The plurality of ROs 702 may include the ROs available for random access communications in a periodic cycle of ROs. The plurality of ROs 702 may include the ROs 704, 706, 708. In certain cases, the first set of ROs may be or include a subset of ROs of the plurality of ROs 702. In certain aspects, the mapping 700A may indicate time-frequency resource(s) allocated for each of the RO(s) 704, 706 of the first set of ROs (or a subset thereof), such as the time and frequency location(s) for each of the RO(s) 704, 706 of the first set of ROs (or a subset thereof). The mapping 700A may indicate that a second set of ROs (for example, including the RO(s) 708 depicted with the label “0”) are deactivated among the plurality of ROs 702 available for random access communications. The second set of ROs may be RO(s) that are deactivated (or unused) for random access communications and/or not associated with the SSB(s) of the first set of ROs.

In certain aspects, an explicit indication of the mapping 700A may be or include a bitmap corresponding to the plurality of ROs 702 and indicating the first set of ROs is activated among the plurality of ROs 702. The bitmap may include a sequence of bits or a bit string, where each bit corresponds to a different RO (and/or a different set of time-frequency resources) of the plurality of ROs 702. A bit having a value of ‘1’ may indicate that the corresponding RO 704, 706 is activated, and a bit having a value of ‘0’ may indicate that the corresponding RO 708 is deactivated. Note that any suitable time-frequency granularity may be used for the bits of the bitmap, such as an RO per bit or a set of time-frequency resources per bit. The time-frequency granularity and/or mapping of bits to time-frequency resource(s) for the bitmap may be preconfigured and/or established according to certain mapping rule(s).

In certain aspects, an explicit indication of the mapping 700A may be or include an indication of a pattern of RO(s) within the plurality of ROs 702. The pattern of RO(s) may indicate the arrangement of the first set of ROs in the plurality of ROs 702 or in specific time-frequency resource(s) allocated for the first set of ROs. The indication of the pattern may be a selection of the pattern among a plurality of patterns, for example, via a pattern identity or index among a list of pattern identities or indexes. The explicit indication of the mapping 700A may be or include an index associated with a specific RO pattern.

In certain aspects, a machine learning (ML) model may be configured and/or trained to output an explicit indication of the mapping 700A. A network entity and/or UE may employ the ML model to determine the mapping 700A. For example, the ML model may obtain input data (e.g., traffic load information, channel conditions, UE capabilities associated with an SSB or a coverage thereof) and provide output data that indicates or includes the mapping 700A. The ML model may be deployed at or in a UE and/or a network entity. For example, the ML model may be deployed at both the network entity and the ML model so both can derive the same SSB to RO mapping.

FIG. 7B depicts an example mapping 700B of an RO group 710 to one or more SSBs. In this example, the mapping 700B may indicate the time-frequency resource(s) allocated for the RO(s) 712a-d of the RO group 710 associated with one or more SSBs (for example, the SSBs 612a-d). In certain cases, the mapping 700B may indicate time-frequency resource(s) allocated for an initial PRACH transmission and PRACH repetition transmission(s) of the RO group 710. For example, the RO group may include ROs 712a-d, where the first RO 712a is allocated for an initial PRACH transmission and the next RO(s) 712b-d are allocated for one or more PRACH repetition transmission(s). In certain case, the mapping 700B may indicate an RO allocation with frequency hopping for the PRACH repetition transmission(s) of the RO group 710. The mapping 700B may indicate a frequency hopping pattern for the RO(s) of the RO group. As an example, the first RO 712a of the RO group 710 may occupy one or more first frequency resources (e.g., one or more resource blocks), and the second RO 712b may occupy one or more second frequency resources different from (e.g., non-overlapping in the frequency domain with) the one or more first frequency resources. Accordingly, the dynamic RO-to-SSB mapping(s) described herein may allow a flexible RO allocation for the RO group 710 that includes PRACH repetition transmission(s) with or without frequency hopping.

In certain aspects, the dynamic RO-to-SSB mapping described herein may take into account or be based on one or more communication conditions associated with a transmission beam associated with an SSB or a coverage area thereof, such as based on traffic load, channel conditions, UE capabilities, etc. As the communication condition(s) change over time, the network entity may modify the dynamic RO-to-SSB mapping associated with an SSB. For example, a UE may obtain, from a network entity, a first SSB-specific mapping of a set of ROs to an SSB, and then at an occasion later in time, the UE may obtain, from the network entity, a second SSB-specific mapping of a set of ROs to the SSB. The second SSB-specific mapping may reallocate or redistribute the set of ROs across the ROs available for random access communications. In certain aspects, the second SSB-specific mapping may adjust (e.g., increase or decrease) the total number of ROs allocated for the SSB.

In certain aspects, the UE may send, to the network entity, a recommendation for the RO-to-SSB mapping associated with one or more SSB(s), such as the mapping 700A, 700B. The UE may determine the RO-to-SSB mapping associated with the SSB(s) based on various communication conditions encountered by or known to the UE including, for example, a traffic load, quality of service (QOS) specification(s) associated with traffic, radio measurement(s), and/or the capabilities of the UE (e.g., coverage capabilities). In certain aspects, the network entity may poll the UE(s) to provide recommendation(s) for the RO-to-SSB mapping associated with one or more SSB(s). For example, the network entity may send, to one or more UEs, a request for the recommendation for the RO-to-SSB mapping. The network entity may determine the RO-to-SSB mapping to use for one or more SSB(s) based on the recommendation(s) obtained from UE, such as a weighted average or the like.

In certain aspects, the dynamic RO-to-SSB mapping(s) may be for a subset of SSB(s) of a plurality of SSBs (e.g., the SSBs of an SSB burst). As an example, the mapping 700A may be an example of a group mapping that indicates multiple RO-to-SSB mappings. The mapping 700A may indicate that first ROs 704 are associated with the first SSB 612a of FIG. 6A, and second ROs 706 are associated with the second SSB 612b of FIG. 6A. In certain cases, a network entity may perform a transmission beam sweep by sending up to N SSBs (e.g., 64 SSBs) in an SSB burst (e.g., a periodic cycle of SSB transmissions, for example, in a half frame) using a different transmission beam per SSB of the SSB burst. The RO-to-SSB mapping(s) may be for a subset of the SSB(s) of the SSB burst, and the UE may determine the RO-to-SSB mapping(s) for the remaining SSBs of the SSB burst according to certain mapping rule(s) as discussed herein. A UE may obtain an indication of the subset of SSBs (or a sub-selection of such SSBs) that have the dynamic RO-to-SSB mapping(s). In certain aspects, the group mapping may be communicated via system information associated with the subset of SSBs.

In certain aspects, the dynamic RO-to-SSB mapping(s) may indicate or be associated with certain parameter(s) for random access communications specific to the RO(s) of the mapping(s). For example, the dynamic RO-to-SSB mapping(s) may indicate a PRACH format used for the RO(s) of the mapping(s), a subcarrier spacing for PRACH transmission(s) in the RO(s), a RAR window size, a preamble received target power, a reference signal received power (RSRP) threshold for SSB selection for the SSB(s), or the like. In certain aspects, a configuration for the dynamic RO-to-SSB mapping(s) may indicate or include the parameter(s) for random access communications specific to the RO(s) of the mapping. For example, the configuration for the dynamic RO-to-SSB mapping(s) may be communicated via system information, RRC signaling, MAC signaling, and/or DCI. In certain aspects, the parameter(s) for random access communications specific to the RO(s) of the mapping may be preconfigured and/or established according to certain rule(s) for the dynamic mapping.

Note that FIGS. 6A-7B are described herein with respect to mapping of RO(s) to SSB(s) to facilitate an understanding of configuring an association between an RO and a transmission beam. Aspects of the present disclosure may applied to configuring an association between an RO and any other suitable signaling that is indicative of (or corresponds to) a transmission beam (e.g., a CSI-RS, on-demand synchronization signaling, a discovery reference signal (DRS), etc.).

### Example Signaling of Dynamic Mapping of Random Access Occasions to Beams

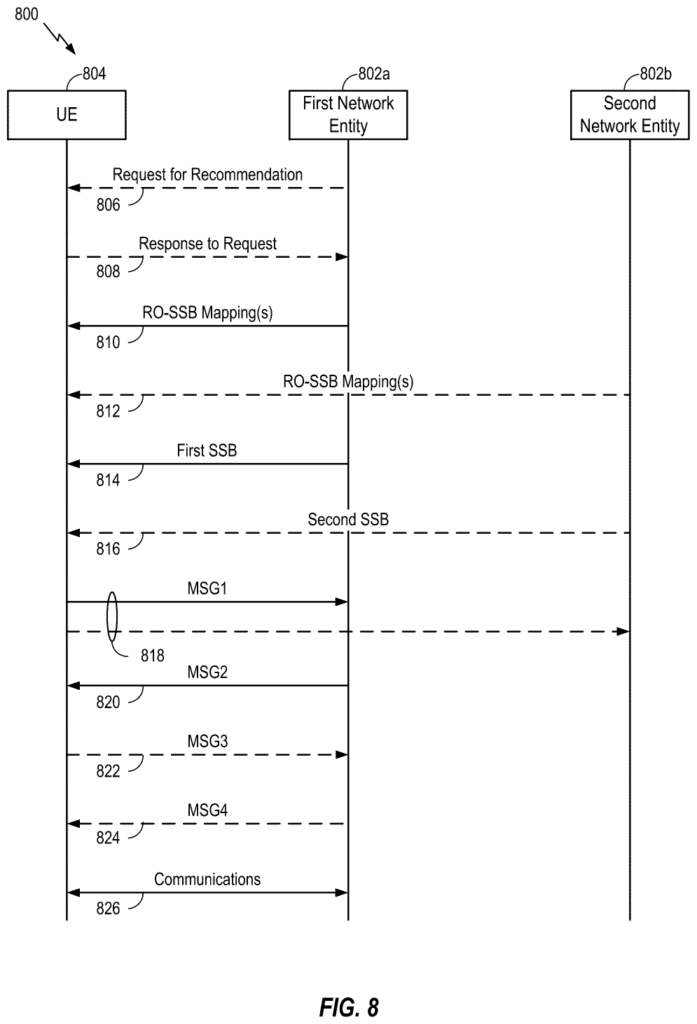

FIG. 8 depicts a process flow 800 for dynamic mapping of random access occasions to beams in a system including a first network entity 802a, a second network entity 802b, and a user equipment (UE) 804. In some aspects, the network entity 802a, 802b may be an example of the BS 102 depicted and described with respect to FIGS. 1 and 3 or a disaggregated base station depicted and described with respect to FIG. 2. In certain aspects, the first network entity 802a may be an example of the first network entity 602a of FIG. 6A, and the second network entity 802b may be an example of the second network entity 602b of FIG. 6A. Similarly, the UE 804 may be an example of UE 104 depicted and described with respect to FIGS. 1 and 3. However, in other aspects, UE 804 may be another type of wireless communications device and the network entity 802a, 802b may be another type of network entity or network node, such as those described herein. Note that any operations or signaling illustrated with dashed lines may indicate that that operation or signaling is an optional or alternative example.

At 806, the UE 804 obtains, from the first network entity 802a, a request for a recommendation on an allocation for one or more random access occasions for a first SSB (e.g., the first SSB 612a) or for multiple different SSBs. The request may be communicated via RRC signaling, MAC signaling, and/or DCI.

At 808, the UE 804 sends, to the first network entity 802a, an indication of a subset of ROs of a plurality of ROs available for random access communications for the first SSB, or each of the multiple different SSBs, in response to the request. The UE 804 may determine the subset of ROs based on radio measurement(s), traffic load, QoS specification(s) for traffic, and/or capabilities of the UE 804 (e.g., coverage capabilities). In some aspects, the indication of the subset of ROs may include a capability associated with the UE 804, such as a capability for the UE 804 to support a dynamic mapping of ROs to beams.

At 810, the UE 804 obtains, from the first network entity 802a, an indication of a first mapping of a first subset of ROs of a plurality of ROs to the first SSB. In certain aspects, the first subset of ROs may be allocated for the first SSB based on the response communicated at 808. In certain aspects, the first network entity 802a may determine the first subset of ROs based on radio measurement(s), traffic load, QoS specification(s) for traffic, and/or capabilities of the UE 804. As an example with respect to FIG. 6B, the first subset of ROs may include the first RO 614a and the second RO 614b. In certain aspects, the first subset of ROs may include an RO group associated with the first SSB, and the RO group may include one or more ROs allocated for PRACH transmission repetition(s). The indication may be included in a configuration for random access communications. The indication may be an explicit indication of the first mapping, such as a bitmap of the first mapping, selection or indication of a RO pattern among a plurality of RO patterns, or the like. In certain aspects, the indication may be or include input data for a machine learning model configured to output the first subset of ROs. In certain aspects, the indication may be communicated via SSB-specific signaling, such as system information (e.g., RMSI or SIB). The indication may be communicated via system information, RRC signaling, MAC signaling, and/or DCI. In certain aspects, the first mapping may be associated with or indicate one or more parameter(s) for random access communications specific to the first SSB.

At 812, the UE 804 obtains, from the second network entity 802b, an indication of a second mapping of a second subset of ROs of a plurality of ROs to a second SSB (e.g., the second SSB 612b), for example, as described herein with respect to the indication of the first mapping at 810. As an example with respect to FIG. 6B, the second subset of ROs may include the third RO 614c and the fourth RO 614d. The first subset of ROs may at least partially overlap in time with second subset of ROs. The indication may be communicated via system information, RRC signaling, MAC signaling, and/or DCI.

In certain aspects, the UE 804 may obtain a group mapping for multiple SSBs. The group mapping may include multiple mappings for multiple SSBs, such as the first mapping and/or the second mapping, for example, as described herein with respect to FIG. 7A. As an example, the indication of the first mapping may be included in a group mapping for multiple SSBs, and the group mapping may include other RO-to-SSB mappings. The indication of the group mapping may be communicated via system information, RRC signaling, MAC signaling, and/or DCI. In certain cases, the UE 804 may obtain the group mapping, the first mapping, and/or the second mapping from the first network entity 802a or the second network entity 802b.

At 814, the UE 804 obtains, from the first network entity 802a, the first SSB, which may correspond to a first transmission beam of the first network entity 802a. The first network entity 802a may send the first SSB via the first transmission beam, for example, as depicted in FIG. 6A. The UE 804 may measure one or more radio measurement(s) associated with the first SSB, for example, a signal-to-noise ratio (SNR), a signal-to-interference plus noise ratio (SINR), a signal-to-noise-plus-distortion ratio (SNDR), a received signal strength indicator (RSSI), a reference signal received power (RSRP), a reference signal received quality (RSRQ), and/or a block error rate (BLER). The UE 804 may select the first SSB for random access communications based on the radio measurement(s) associated with the first SSB. For example, the RSRP associated with the first SSB may satisfy an RSRP threshold configured for random access communications.

At 816, the UE 804 obtains, from the second network entity 802b, the second SSB. The second SSB may correspond to a second transmission beam of the second network entity 802b. The second network entity 802b may send the second SSB via the second transmission beam, for example, as depicted in FIG. 6A. The UE 804 may measure one or more radio measurement(s) associated with the second SSB. The UE 804 may select the second SSB for random access communications based on the radio measurement(s) associated with the second SSB. In certain cases, the explicit indication of the mapping(s) at 810 and/or 812 may be carried or conveyed via the first SSB and/or the second SSB, for example, via system information, which may be or include SSB-specific RMSI and/or SIB.

At 818, the UE 804 sends, to the first network entity 802a, a first random access preamble (MSG1) in the RO(s) (e.g., the RO group) associated with the first SSB according to the first mapping obtained at 810. The UE 804 may also send, to the second network entity 802b, a second random access preamble in the RO(s) (e.g., the RO group) associated with the second SSB according to the second mapping. As an example with respect to FIGS. 6A and 6B, the UE 804 may send the first random access preamble in the first RO 614a and/or the second RO 614b, and the UE 804 may send the second random access preamble in the third RO 614c and/or the fourth RO 614d. The first mapping and the second mapping may allow the UE 804 to initiate random access communications with multiple TRPs (e.g., the first network entity 802a and the second network entity 802b) simultaneously. Thus, the first mapping and the second mapping may enable reduced latencies (e.g., via simultaneous or time-overlapping ROs and/or RO groups per TRP), spatial diversity (e.g., via multiple TRPs), and/or coverage enhancements (e.g., via RO(s) for repetition(s) of a preamble transmission).

At 820, the UE 804 obtains, from the first network entity 802a, a random access response (RAR) associated with the preamble transmission(s). The RAR may also be referred to as MSG2. In certain aspects, the RAR may be communicated via a PDCCH and PDSCH transmission. For example, the UE 804 may obtain, from the first network entity 802a, a PDCCH transmission (e.g., DCI) scheduling the RAR on a PDSCH, and then the UE 804 may obtain, from the first network entity 802a, a PDSCH transmission carrying the RAR (e.g., a medium access control (MAC) protocol data unit (PDU) with a RAR payload associated with the preamble) in accordance with the scheduling indicated in the DCI. The RAR payload may indicate or include an UL grant for MSG3, for example, for a contention based random access (CBRA) procedure. For a contention-free random access (CFRA) procedure, the random access procedure may be considered successful upon the UE's reception of the RAR, and contention resolution may not be performed (for example, communication of MSG3 and MSG4). In certain aspects, the RAR payload may indicate or include timing advance information, which may allow the UE 804 to (re-)synchronize timing (e.g., signal propagation delay) for communications with the first network entity 802a.

At 822, the UE 804 sends, to the first network entity 802a, MSG3 via a PUSCH in accordance with the UL grant indicated in the RAR. As an example, MSG3 may indicate or include an RRC connection request, a tracking area update, and/or a scheduling request (for an UL transmission). The UE 804 may send MSG3 for a CBRA procedure.

At 824, the UE 804 obtains, from the first network entity 802a, a contention resolution message (MSG4) in response to MSG3. In some cases, the MSG4 may include an RRC connection setup message in response to the RRC connection request and/or an UL grant in response to the scheduling request, for example. The UE 804 may obtain MSG4 for a CBRA procedure.

At 826, the UE 804 communicates with the first network entity 802a based on the RACH communications. As an example, the UE 804 may apply any configuration for communications between the UE 804 and the first network entity 802a as indicated or included in MSG2 and/or MSG4 (e.g., the RRC connection setup message). As discussed above, MSG2 may indicate or include a timing advance command that allows the UE 804 to synchronize communications with the first network entity 802, for example, in terms of a signal propagation delay between the UE 804 and the first network entity 802a. The RRC connection setup message may indicate or include various configurations, such as configuration(s) for control signaling (e.g., a PDCCH or a control resource set), PUSCH, PUCCH, PDSCH, transmit power control(s), radio measurement(s), radio measurement reporting (e.g., CSI reporting), SRS, antenna configuration, and/or scheduling requests. In certain aspects, the configuration provided in the RRC connection setup message may facilitate the reception of subsequent configurations. In some cases, the UE 804 may transmit an UL signal in accordance with the UL grant provided in MSG4. In certain aspects, the random access communications at 820-826 may be performed between the UE 804 and the second network entity 802b in addition to or as an alternative.

Note that certain aspects of the process flow illustrated in FIG. 8 is an example of a random access procedure, and aspects of the present disclosure may be applied to various random access procedures, such as CFRA, CBRA, four-step random access, and/or two-step random access. Note that the process flow illustrated in FIG. 8 is described herein to facilitate an understanding of dynamic mapping of RO(s) to SSB(s), and aspects of the present disclosure may be performed in various manners via alternative or additional signaling and/or operations. In certain aspects, the operations and/or signaling of FIG. 8 may occur in an order different from that described or depicted, and various actions, operations, and/or signaling may be added, omitted, or combined.

### Example Operations of Dynamic Mapping of Random Access Occasions to Beams

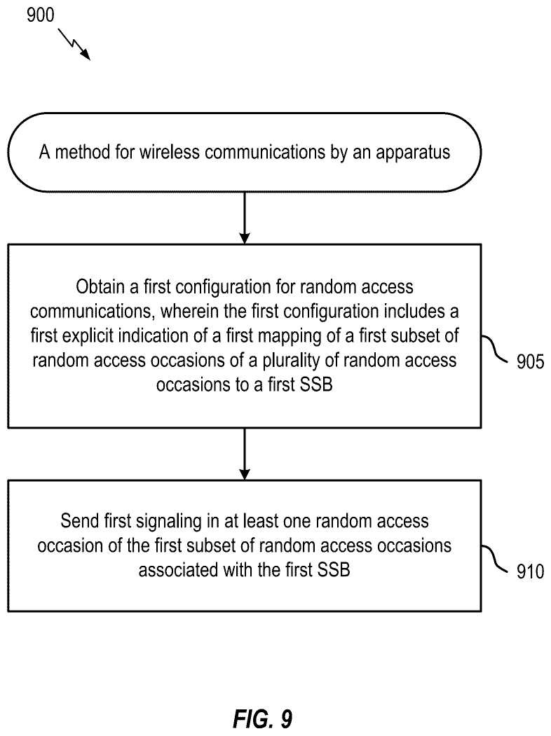

FIG. 9 shows a method 900 for wireless communications by an apparatus, such as UE 104 of FIGS. 1 and 3.

Method 900 begins at block 905 with obtaining a first configuration for random access communications, wherein the first configuration includes a first explicit indication of a first mapping of a first subset of random access occasions of a plurality of random access occasions to a first SSB. As an example, obtaining the first configuration may be an example of obtaining the first RO-SSB mapping at 810 of FIG. 8. In certain aspects, the first explicit indication includes a bitmap corresponding to the plurality of random access occasions that indicates the first subset of random access occasions. In certain aspects, the first explicit indication includes an indication of a pattern within the plurality of random access occasions, the pattern corresponding to the first subset of random access occasions. As an example, the indication of the pattern may be or include an index or identity associated with the pattern among a plurality of patterns.

Method 900 then proceeds to block 910 with sending first signaling in at least one random access occasion of the first subset of random access occasions associated with the first SSB. As an example, the first signaling may include a PRACH transmission, such as a random access preamble, for example, as described herein with respect to FIG. 8.

In certain aspects, the first subset of random access occasions includes a different total number of random access occasions allocated for the first SSB than a total number of random access occasions allocated for a second SSB.

In certain aspects, the first configuration includes a second explicit indication of a second mapping of a second subset of random access occasions of the plurality of random access occasions to a second SSB. In certain aspects, the first subset of random access occasions has a first total number of random access occasions; the second subset of random access occasions has a second total number of random access occasions; and the first total number of random access occasions is different from the second total number of random access occasions.

In certain aspects, the first subset of random access occasions at least partially overlaps in time with the second subset of random access occasions for example, as described herein with respect to FIG. 6B; the first SSB is associated with a first transmission-reception point (e.g., the first network entity 602a of FIG. 6A); and the second SSB is associated with a second transmission-reception point (e.g., the second network entity 602b of FIG. 6A). In certain aspects, the first subset of random access occasions includes one or more first repetition occasions for a first random access occasion; the second subset of random access occasions includes one or more second repetition occasions for a second random access occasion; and the one or more first repetitions at least partially overlap in time with the one or more second repetition occasions, for example, as described herein with respect to FIG. 6B.

In certain aspects, the first subset of random access occasions includes one or more repetition occasions for a random access occasion.

In certain aspects, the first configuration includes system information (e.g., SSB-specific RMSI or SIB) that is specific to the first SSB; and the system information includes the first explicit indication.

In certain aspects, the first explicit indication includes input data for a machine learning model configured to output the first subset of random access occasions. In certain aspects, method 900 further includes providing the input data to the machine learning model. In certain aspects, method 900 further includes obtaining, from the machine learning model, output data that indicates the first subset of random access occasions.

In certain aspects, method 900 further includes obtaining, after obtaining the first configuration, a second configuration for random access communications, wherein the second configuration includes a second explicit indication of a second mapping of a second subset of random access occasions of the plurality of random access occasions to the first SSB, wherein the first subset of random access occasions is different from the second subset of random access occasions. In certain aspects, method 900 further includes sending second signaling in at least one random access occasion of the second subset of random access occasions associated with the first SSB.

In certain aspects, method 900 further includes sending an indication of a second subset of random access occasions of the plurality of random access occasions for the first SSB. In certain aspects, method 900 further includes obtaining a request for a recommendation on an allocation for one or more random access occasions for the first SSB; and sending the indication of the second subset of random access occasions comprises sending the indication of the second subset of random access occasions in response to the request.

In certain aspects, method 900 further includes obtaining an indication of a set of SSBs, including the first SSB, that has, for each SSB of the set of SSBs, an SSB-specific subset of random access occasions, wherein the respective SSB-specific subset of random access occasions for the first SSB includes the first subset of random access occasions. In certain aspects, the first configuration includes a second explicit indication of a set of mappings for a subset of SSBs of a plurality of SSBs; each mapping of the set of mappings includes an association between one or more random access occasions and at least one SSB of the subset of SSBs; the set of mappings includes the first mapping; and the second explicit indication includes the first explicit indication.

In certain aspects, the first subset of random access occasions indicates (or is associated with) one or more parameters for random access communications. In certain aspects, the one or more parameters comprise a physical random access channel format (e.g., a short PRACH format or a long PRACH format) for the at least one random access occasion or the like.

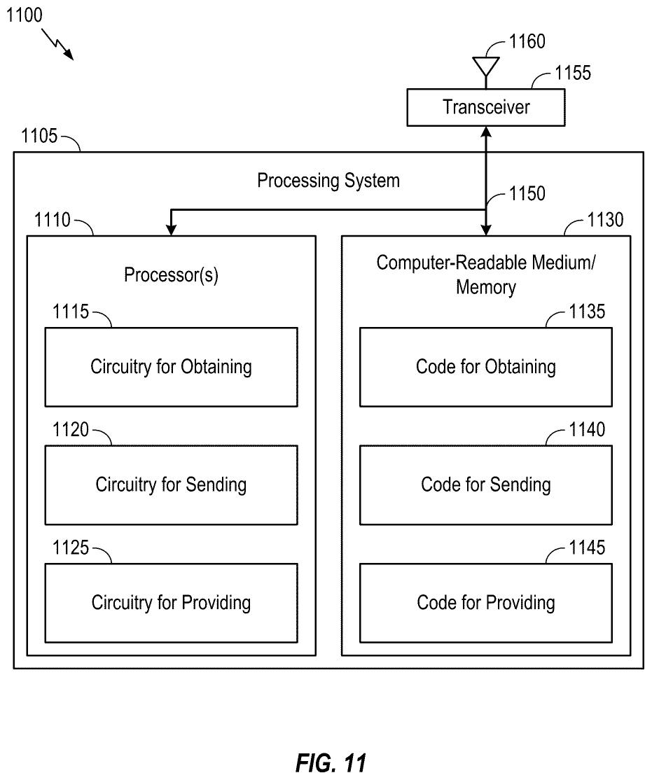

In certain aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

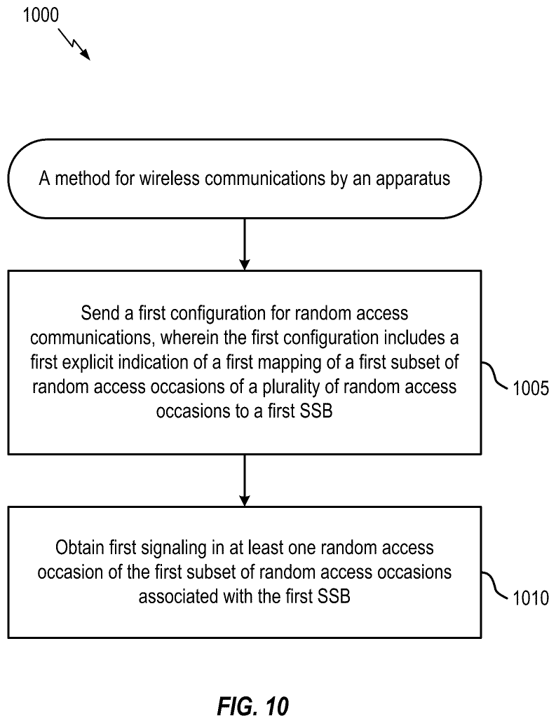

FIG. 10 shows a method 1000 for wireless communications by an apparatus, such as BS 102 of FIGS. 1 and 3, or a disaggregated base station as discussed with respect to FIG. 2.

Method 1000 begins at block 1005 with sending a first configuration for random access communications, wherein the first configuration includes a first explicit indication of a first mapping of a first subset of random access occasions of a plurality of random access occasions to a first SSB. As an example, sending the first configuration may be an example of sending the first RO-SSB mapping at 810 of FIG. 8. In certain aspects, the first explicit indication includes a bitmap corresponding to the plurality of random access occasions that indicates the first subset of random access occasions. In certain aspects, the first explicit indication includes an indication of a pattern within the plurality of random access occasions, the pattern corresponding to the first subset of random access occasions.

Method 1000 then proceeds to block 1010 with obtaining first signaling in at least one random access occasion of the first subset of random access occasions associated with the first SSB. As an example, the first signaling may include a PRACH transmission, such as a random access preamble, for example, as described herein with respect to FIG. 8.

In certain aspects, the first subset of random access occasions includes a different total number of random access occasions allocated for the first SSB than a total number of random access occasions allocated for a second SSB.

In certain aspects, the first configuration includes a second explicit indication of a second mapping of a second subset of random access occasions of the plurality of random access occasions to a second SSB. In certain aspects, the first subset of random access occasions has a first total number of random access occasions; the second subset of random access occasions has a second total number of random access occasions; and the first total number of random access occasions is different from the second total number of random access occasions.

In certain aspects, the first subset of random access occasions at least partially overlaps in time with the second subset of random access occasions; the first SSB is associated with a first transmission-reception point; and the second SSB is associated with a second transmission-reception point. In certain aspects, the first subset of random access occasions includes one or more first repetition occasions for a first random access occasion; the second subset of random access occasions includes one or more second repetition occasions for a second random access occasion; and the one or more first repetition occasions at least partially overlap in time with the one or more second repetition occasions.

In certain aspects, the first subset of random access occasions includes one or more repetition occasions for a random access occasion.

In certain aspects, the first configuration includes system information (e.g., SSB-specific RMSI or SIB) that is specific to the first SSB; and the system information includes the first explicit indication.

In certain aspects, the first explicit indication includes input data for a machine learning model configured to output the first subset of random access occasions.

In certain aspects, method 1000 further includes providing input data to a machine learning model. In certain aspects, method 1000 further includes obtaining, from the machine learning model, output data that indicates the first subset of random access occasions.

In certain aspects, method 1000 further includes sending, after send the first configuration, a second configuration for random access communications, wherein the second configuration includes a second explicit indication of a second mapping of a second subset of random access occasions of the plurality of random access occasions to the first SSB, wherein the first subset of random access occasions is different from the second subset of random access occasions.

In certain aspects, method 1000 further includes obtaining second signaling in at least one random access occasion of the second subset of random access occasions associated with the first SSB.

In certain aspects, method 1000 further includes obtaining an indication of a second subset of random access occasions of the plurality of random access occasions for the first SSB. In certain aspects, method 1000 further includes sending a request for a recommendation on an allocation for one or more random access occasions for the first SSB; and obtaining the indication of the second subset of random access occasions comprises obtaining the indication of the second subset of random access occasions in response to the request.

In certain aspects, method 1000 further includes obtaining an indication of a set of SSBs, including the first SSB, that has, for each SSB of the set of SSBs, an SSB-specific subset of random access occasions, wherein the respective SSB-specific subset of random access occasions for the first SSB includes the first subset of random access occasions. In certain aspects, the first configuration includes a second explicit indication of a set of mappings for a subset of SSBs of a plurality of SSBs; each mapping of the set of mappings includes an association between one or more random access occasions and at least one SSB of the subset of SSBs; the set of mappings includes the first mapping; and the second explicit indication includes the first explicit indication.

In certain aspects, the first subset of random access occasions indicates one or more parameters for random access communications. In certain aspects, the one or more parameters comprise a physical random access channel format for the at least one random access occasion or the like.

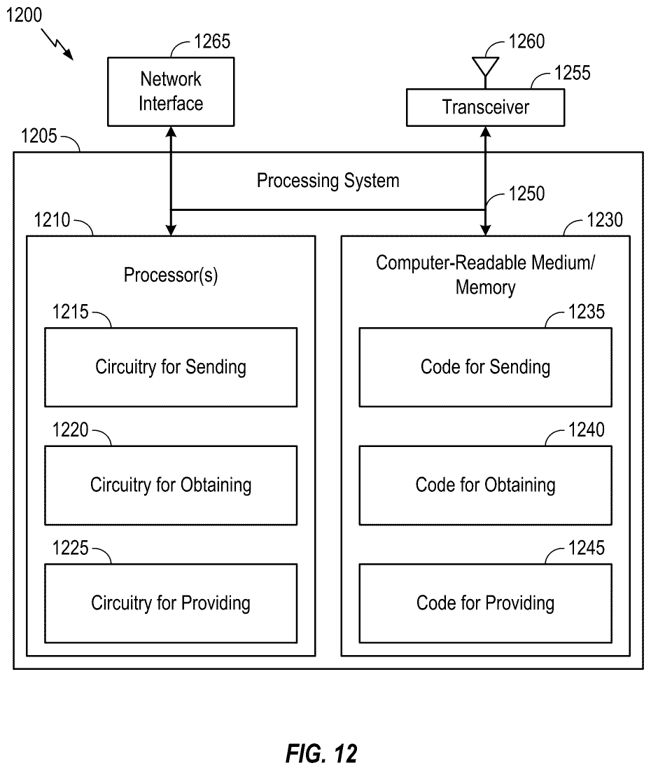

In certain aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Communications Devices

FIG. 11 depicts aspects of an example communications device 1100. In some aspects, communications device 1100 is a user equipment, such as UE 104 described above with respect to FIGS. 1 and 3.

The communications device 1100 includes a processing system 1105 coupled to a transceiver 1155 (e.g., a transmitter and/or a receiver). The transceiver 1155 is configured to transmit and receive signals for the communications device 1100 via an antenna 1160, such as the various signals as described herein. The processing system 1105 may be configured to perform processing functions for the communications device 1100, including processing signals received and/or to be transmitted by the communications device 1100.

The processing system 1105 includes one or more processors 1110. In various aspects, the one or more processors 1110 may be representative of one or more of receive processor 358, transmit processor 364, TX MIMO processor 366, and/or controller/processor 380, as described with respect to FIG. 3. The one or more processors 1110 are coupled to a computer-readable medium/memory 1130 via a bus 1150. In certain aspects, the computer-readable medium/memory 1130 is configured to store instructions (e.g., computer-executable code) that when executed by the one or more processors 1110, enable and cause the one or more processors 1110 to perform the method 900 described with respect to FIG. 9, or any aspect related to it, including any operations described in relation to FIG. 9. Note that reference to a processor performing a function of communications device 1100 may include one or more processors performing that function of communications device 1100, such as in a distributed fashion.

In the depicted example, computer-readable medium/memory 1130 stores code for obtaining 1135, code for sending 1140, and code for providing 1145. Processing of the code 1135-1145 may enable and cause the communications device 1100 to perform the method 900 described with respect to FIG. 9, or any aspect related to it.

The one or more processors 1110 include circuitry configured to implement (e.g., execute) the code stored in the computer-readable medium/memory 1130, including circuitry for obtaining 1115, circuitry for sending 1120, and circuitry for providing 1125. Processing with circuitry 1115-1125 may enable and cause the communications device 1100 to perform the method 900 described with respect to FIG. 9, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1155 and/or antenna 1160 of the communications device 1100 in FIG. 11, and/or one or more processors 1110 of the communications device 1100 in FIG. 11. Means for communicating, receiving or obtaining may include the transceivers 354, antenna(s) 352, receive processor 358, AI processor 370, and/or controller/processor 380 of the UE 104 illustrated in FIG. 3, transceiver 1155 and/or antenna 1160 of the communications device 1100 in FIG. 11, and/or one or more processors 1110 of the communications device 1100 in FIG. 11.

FIG. 12 depicts aspects of an example communications device 1200. In some aspects, communications device 1200 is a network entity, such as BS 102 of FIGS. 1 and 3, or a disaggregated base station as discussed with respect to FIG. 2.

The communications device 1200 includes a processing system 1205 coupled to a transceiver 1255 (e.g., a transmitter and/or a receiver) and/or a network interface 1265. The transceiver 1255 is configured to transmit and receive signals for the communications device 1200 via an antenna 1260, such as the various signals as described herein. The network interface 1265 is configured to obtain and send signals for the communications device 1200 via communications link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210. In various aspects, one or more processors 1210 may be representative of one or more of receive processor 338, transmit processor 320, TX MIMO processor 330, and/or controller/processor 340, as described with respect to FIG. 3. The one or more processors 1210 are coupled to a computer-readable medium/memory 1230 via a bus 1250. In certain aspects, the computer-readable medium/memory 1230 is configured to store instructions (e.g., computer-executable code) that when executed by the one or more processors 1210, enable and cause the one or more processors 1210 to perform the method 1000 described with respect to FIG. 10, or any aspect related to it, including any operations described in relation to FIG. 10. Note that reference to a processor of communications device 1200 performing a function may include one or more processors of communications device 1200 performing that function, such as in a distributed fashion.

In the depicted example, the computer-readable medium/memory 1230 stores code for sending 1235, code for obtaining 1240, and code for providing 1245. Processing of the code 1235-1245 may enable and cause the communications device 1200 to perform the method 1000 described with respect to FIG. 10, or any aspect related to it.

The one or more processors 1210 include circuitry configured to implement (e.g., execute) the code stored in the computer-readable medium/memory 1230, including circuitry for sending 1215, circuitry for obtaining 1220, and circuitry for providing 1225. Processing with circuitry 1215-1225 may enable and cause the communications device 1200 to perform the method 1000 described with respect to FIG. 10, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1255, antenna 1260, and/or network interface 1265 of the communications device 1200 in FIG. 12, and/or one or more processors 1210 of the communications device 1200 in FIG. 12. Means for communicating, receiving or obtaining may include the transceivers 332, antenna(s) 334, receive processor 338, AI processor 318, and/or controller/processor 340 of the BS 102 illustrated in FIG. 3, transceiver 1255, antenna 1260, and/or network interface 1265 of the communications device 1200 in FIG. 12, and/or one or more processors 1210 of the communications device 1200 in FIG. 12.

### EXAMPLE CLAUSES

### Implementation Examples are Described in the Following Numbered Clauses:

Clause 1: A method for wireless communications by an apparatus comprising: obtaining a first configuration for random access communications, wherein the first configuration includes a first explicit indication of a first mapping of a first subset of random access occasions of a plurality of random access occasions to a first SSB; and sending first signaling in at least one random access occasion of the first subset of random access occasions associated with the first SSB.

Clause 2: The method of Clause 1, wherein the first subset of random access occasions includes a different total number of random access occasions allocated for the first SSB than a total number of random access occasions allocated for a second SSB.

Clause 3: The method of any one of Clauses 1-2, wherein the first configuration includes a second explicit indication of a second mapping of a second subset of random access occasions of the plurality of random access occasions to a second SSB.

Clause 4: The method of Clause 3, wherein: the first subset of random access occasions has a first total number of random access occasions; the second subset of random access occasions has a second total number of random access occasions; and the first total number of random access occasions is different from the second total number of random access occasions.

Clause 5: The method of Clause 3 or 4, wherein: the first subset of random access occasions at least partially overlaps in time with the second subset of random access occasions; the first SSB is associated with a first transmission-reception point; and the second SSB is associated with a second transmission-reception point.

Clause 6: The method of any one of Clauses 3-5, wherein: the first subset of random access occasions includes one or more first repetition occasions for a first random access occasion; the second subset of random access occasions includes one or more second repetition occasions for a second random access occasion; and the one or more first repetition occasions at least partially overlap in time with the one or more second repetition occasions.

Clause 7: The method of any one of Clauses 1-6, wherein the first subset of random access occasions includes one or more repetition occasions for a random access occasion.

Clause 8: The method of any one of Clauses 1-7, wherein: the first configuration includes system information that is specific to the first SSB; and the system information includes the first explicit indication.

Clause 9: The method of any one of Clauses 1-8, wherein the first explicit indication includes a bitmap corresponding to the plurality of random access occasions that indicates the first subset of random access occasions.

Clause 10: The method of any one of Clauses 1-9, wherein the first explicit indication includes an indication of a pattern within the plurality of random access occasions, the pattern corresponding to the first subset of random access occasions.

Clause 11: The method of any one of Clauses 1-10, wherein the first explicit indication includes input data for a machine learning model configured to output the first subset of random access occasions.

Clause 12: The method of Clause 11, further comprising: providing the input data to the machine learning model; and obtaining, from the machine learning model, output data that indicates the first subset of random access occasions.

Clause 13: The method of any one of Clauses 1-12, further comprising: obtaining, after obtaining the first configuration, a second configuration for random access communications, wherein the second configuration includes a second explicit indication of a second mapping of a second subset of random access occasions of the plurality of random access occasions to the first SSB, wherein the first subset of random access occasions is different from the second subset of random access occasions; and sending second signaling in at least one random access occasion of the second subset of random access occasions associated with the first SSB.

Clause 14: The method of any one of Clauses 1-13, further comprising sending an indication of a second subset of random access occasions of the plurality of random access occasions for the first SSB.

Clause 15: The method of Clause 14, further comprising obtaining a request for a recommendation on an allocation for one or more random access occasions for the first SSB; and sending the indication of the second subset of random access occasions comprises sending the indication of the second subset of random access occasions in response to the request.

Clause 16: The method of any one of Clauses 1-15, further comprising obtaining an indication of a set of SSBs, including the first SSB, that has, for each SSB of the set of SSBs, an SSB-specific subset of random access occasions, wherein the respective SSB-specific subset of random access occasions for the first SSB includes the first subset of random access occasions.

Clause 17: The method of any one of Clauses 1-16, wherein: the first configuration includes a second explicit indication of a set of mappings for a subset of SSBs of a plurality of SSBs; each mapping of the set of mappings includes an association between one or more random access occasions and at least one SSB of the subset of SSBs; the set of mappings includes the first mapping; and the second explicit indication includes the first explicit indication.

Clause 18: The method of any one of Clauses 1-17, wherein the first subset of random access occasions indicates one or more parameters for random access communications.

Clause 19: The method of Clause 18, wherein the one or more parameters comprise a physical random access channel format for the at least one random access occasion.

Clause 20: A method for wireless communications by an apparatus comprising: sending a first configuration for random access communications, wherein the first configuration includes a first explicit indication of a first mapping of a first subset of random access occasions of a plurality of random access occasions to a first SSB; and obtaining first signaling in at least one random access occasion of the first subset of random access occasions associated with the first SSB.

Clause 21: The method of Clause 20, wherein the first subset of random access occasions includes a different total number of random access occasions allocated for the first SSB than a total number of random access occasions allocated for a second SSB.

Clause 22: The method of any one of Clauses 20-21, wherein the first configuration includes a second explicit indication of a second mapping of a second subset of random access occasions of the plurality of random access occasions to a second SSB.

Clause 23: The method of Clause 22, wherein: the first subset of random access occasions has a first total number of random access occasions; the second subset of random access occasions has a second total number of random access occasions; and the first total number of random access occasions is different from the second total number of random access occasions.

Clause 24: The method of Clause 22 or 23, wherein: the first subset of random access occasions at least partially overlaps in time with the second subset of random access occasions; the first SSB is associated with a first transmission-reception point; and the second SSB is associated with a second transmission-reception point.

Clause 25: The method of any one of Clauses 22-24, wherein: the first subset of random access occasions includes one or more first repetition occasions for a first random access occasion; the second subset of random access occasions includes one or more second repetition occasions for a second random access occasion; and the one or more first repetition occasions at least partially overlap in time with the one or more second repetition occasions.

Clause 26: The method of any one of Clauses 20-25, wherein the first subset of random access occasions includes one or more repetition occasions for a random access occasion.

Clause 27: The method of any one of Clauses 20-26, wherein: the first configuration includes system information that is specific to the first SSB; and the system information includes the first explicit indication.

Clause 28: The method of any one of Clauses 20-27, wherein the first explicit indication includes a bitmap corresponding to the plurality of random access occasions that indicates the first subset of random access occasions.

Clause 29: The method of any one of Clauses 20-28, wherein the first explicit indication includes an indication of a pattern within the plurality of random access occasions, the pattern corresponding to the first subset of random access occasions.

Clause 30: The method of any one of Clauses 20-29, wherein the first explicit indication includes input data for a machine learning model configured to output the first subset of random access occasions.

Clause 31: The method of any one of Clauses 20-30, further comprising: providing input data to a machine learning model; and obtaining, from the machine learning model, output data that indicates the first subset of random access occasions.

Clause 32: The method of any one of Clauses 20-31, further comprising: sending, after send the first configuration, a second configuration for random access communications, wherein the second configuration includes a second explicit indication of a second mapping of a second subset of random access occasions of the plurality of random access occasions to the first SSB, wherein the first subset of random access occasions is different from the second subset of random access occasions; and obtaining second signaling in at least one random access occasion of the second subset of random access occasions associated with the first SSB.

Clause 33: The method of any one of Clauses 20-32, further comprising obtaining an indication of a second subset of random access occasions of the plurality of random access occasions for the first SSB.

Clause 34: The method of Clause 33, further comprising sending a request for a recommendation on an allocation for one or more random access occasions for the first SSB; and obtaining the indication of the second subset of random access occasions comprises obtaining the indication of the second subset of random access occasions in response to the request.

Clause 35: The method of any one of Clauses 20-34, further comprising obtaining an indication of a set of SSBs, including the first SSB, that has, for each SSB of the set of SSBs, an SSB-specific subset of random access occasions, wherein the respective SSB-specific subset of random access occasions for the first SSB includes the first subset of random access occasions.

Clause 36: The method of any one of Clauses 20-35, wherein: the first configuration includes a second explicit indication of a set of mappings for a subset of SSBs of a plurality of SSBs; each mapping of the set of mappings includes an association between one or more random access occasions and at least one SSB of the subset of SSBs; the set of mappings includes the first mapping; and the second explicit indication includes the first explicit indication.

Clause 37: The method of any one of Clauses 20-36, wherein the first subset of random access occasions indicates one or more parameters for random access communications.

Clause 38: The method of Clause 37, wherein the one or more parameters comprise a physical random access channel format for the at least one random access occasion.

Clause 39: One or more apparatuses, comprising: one or more memories comprising executable instructions; and one or more processors configured to execute the executable instructions and cause the one or more apparatuses to perform a method in accordance with any one of Clauses 1-38.

Clause 40: One or more apparatuses, comprising: one or more memories; and one or more processors, coupled to the one or more memories, configured to cause the one or more apparatuses to perform a method in accordance with any one of Clauses 1-38.

Clause 41: One or more apparatuses, comprising: one or more memories; and one or more processors, coupled to the one or more memories, configured to perform a method in accordance with any one of Clauses 1-38.

Clause 42: One or more apparatuses, comprising means for performing a method in accordance with any one of Clauses 1-38.

Clause 43: One or more non-transitory computer-readable media comprising executable instructions that, when executed by one or more processors of one or more apparatuses, cause the one or more apparatuses to perform a method in accordance with any one of Clauses 1-38.

Clause 44: One or more computer program products embodied on one or more computer-readable storage media comprising code for performing a method in accordance with any one of Clauses 1-38.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
obtain a first configuration for random access communications, wherein the first configuration includes a first explicit indication of a first mapping of a first subset of random access occasions of a plurality of random access occasions to a first synchronization signal block (SSB); and
send first signaling in at least one random access occasion of the first subset of random access occasions associated with the first SSB.

2. The apparatus of claim 1, wherein the first configuration includes a second explicit indication of a second mapping of a second subset of random access occasions of the plurality of random access occasions to a second SSB.

3. The apparatus of claim 2, wherein:
the first subset of random access occasions at least partially overlaps in time with the second subset of random access occasions;
the first SSB is associated with a first transmission-reception point; and
the second SSB is associated with a second transmission-reception point.

4. The apparatus of claim 3, wherein:
the first subset of random access occasions includes one or more first repetition occasions for a first random access occasion;
the second subset of random access occasions includes one or more second repetition occasions for a second random access occasion; and
the one or more first repetition occasions at least partially overlap in time with the one or more second repetition occasions.

5. The apparatus of claim 1, wherein the first explicit indication includes a bitmap corresponding to the plurality of random access occasions that indicates the first subset of random access occasions.

6. The apparatus of claim 1, wherein the first explicit indication includes an indication of a pattern within the plurality of random access occasions, the pattern corresponding to the first subset of random access occasions.

7. The apparatus of claim 1, wherein the one or more processors are configured to cause the apparatus to:
obtain, after obtaining the first configuration, a second configuration for random access communications, wherein the second configuration includes a second explicit indication of a second mapping of a second subset of random access occasions of the plurality of random access occasions to the first SSB, wherein the first subset of random access occasions is different from the second subset of random access occasions; and
send second signaling in at least one random access occasion of the second subset of random access occasions associated with the first SSB.

8. The apparatus of claim 1, wherein the one or more processors are configured to cause the apparatus to obtain an indication of a set of SSBs, including the first SSB, that has, for each SSB of the set of SSBs, an SSB-specific subset of random access occasions, wherein the respective SSB-specific subset of random access occasions for the first SSB includes the first subset of random access occasions.

9. The apparatus of claim 1, wherein:
the first configuration includes a second explicit indication of a set of mappings for a subset of SSBs of a plurality of SSBs;
each mapping of the set of mappings includes an association between one or more random access occasions and at least one SSB of the subset of SSBs;
the set of mappings includes the first mapping; and
the second explicit indication includes the first explicit indication.

10. The apparatus of claim 1, wherein the first subset of random access occasions indicates one or more parameters for random access communications.

11. An apparatus configured for wireless communications, comprising:
one or more memories; and
one or more processors coupled to the one or more memories, the one or more processors being configured to cause the apparatus to:
send a first configuration for random access communications, wherein the first configuration includes a first explicit indication of a first mapping of a first subset of random access occasions of a plurality of random access occasions to a first synchronization signal block (SSB); and
obtain first signaling in at least one random access occasion of the first subset of random access occasions associated with the first SSB.

12. The apparatus of claim 11, wherein the first configuration includes a second explicit indication of a second mapping of a second subset of random access occasions of the plurality of random access occasions to a second SSB.

13. The apparatus of claim 12, wherein:
the first subset of random access occasions at least partially overlaps in time with the second subset of random access occasions;
the first SSB is associated with a first transmission-reception point; and
the second SSB is associated with a second transmission-reception point.

14. The apparatus of claim 13, wherein:
the first subset of random access occasions includes one or more first repetition occasions for a first random access occasion;
the second subset of random access occasions includes one or more second repetition occasions for a second random access occasion; and
the one or more first repetition occasions at least partially overlap in time with the one or more second repetition occasions.

15. The apparatus of claim 11, wherein the first explicit indication includes a bitmap corresponding to the plurality of random access occasions that indicates the first subset of random access occasions.

16. The apparatus of claim 11, wherein the first explicit indication includes an indication of a pattern within the plurality of random access occasions, the pattern corresponding to the first subset of random access occasions.

17. The apparatus of claim 11, wherein the one or more processors are configured to cause the apparatus to:
send, after send the first configuration, a second configuration for random access communications, wherein the second configuration includes a second explicit indication of a second mapping of a second subset of random access occasions of the plurality of random access occasions to the first SSB, wherein the first subset of random access occasions is different from the second subset of random access occasions; and
obtain second signaling in at least one random access occasion of the second subset of random access occasions associated with the first SSB.

18. The apparatus of claim 11, wherein the one or more processors are configured to cause the apparatus to obtain an indication of a second subset of random access occasions of the plurality of random access occasions for the first SSB.

19. The apparatus of claim 11, wherein:
the first configuration includes a second explicit indication of a set of mappings for a subset of SSBs of a plurality of SSBs;
each mapping of the set of mappings includes an association between one or more random access occasions and at least one SSB of the subset of SSBs;
the set of mappings includes the first mapping; and
the second explicit indication includes the first explicit indication.

20. A method for wireless communications, comprising:
obtaining a first configuration for random access communications, wherein the first configuration includes a first explicit indication of a first mapping of a first subset of random access occasions of a plurality of random access occasions to a first synchronization signal block (SSB); and
sending first signaling in at least one random access occasion of the first subset of random access occasions associated with the first SSB.
